(19) United States
(12) Patent Application Publication
(10) Pub. No.: US 2026/0271830 A1
(43) Pub. Date: Sep. 17, 2026

(54) HARVESTING OPERATION MONITORING

(71) Applicant: AGCO International GmbH, Neuhausen Am Rheinfall (CH)

(72) Inventors: Morten Stigaard LAURSEN, Randers (DK); Martin Peter CHRISTIANSEN, Randers (DK); Andreas Rye ANDERSEN,, Randers (DK)

(21) Appl. No.: 19/471,259

(22) PCT Filed: Feb. 27, 2024
(86) PCT No.: PCT/IB2024/051849

§ 371 Date: Sep. 30, 2025

(30) Foreign Application Priority Data
Mar. 30, 2023 (GB) 2304753.3

(51) Int. Cl. A01D 41/127; A01D 41/12; A01D 41/14

(52) U.S. Cl. CPC A01D 41/1271; A01D 41/1243; A01D 41/141; A01D 41/145

(57) ABSTRACT

Systems and methods for monitoring the operation of one or more crop processing components of an agricultural harvesting machine. Sensor data from an event based sensor is indicative of a measure of a flow of material from a spreader tool of the harvesting machine. This is used to identify one or more anomalous flow regions with the material flow; and subsequently operation of one or more operable components associated with the agricultural machine can be controlled in dependence on the identified anomalous flow region(s).

### CROSS-REFERENCE TO RELATED APPLICATIONS

Not applicable.

### FIELD

Embodiments of the present disclosure relate generally to systems and methods for monitoring the operation of component(s) of an agricultural harvester, and specifically a spreader tool of a harvesting machine.

### BACKGROUND

Information about the technology generally. Agricultural harvesters such as combine harvesters, or “combines”, work to cut crop material from a field before separating the grain from the material other than grain (MOG) (referred to interchangeably as “residue”) on board. Generally, the grain is transferred to a grain bin of the combine (where it may be temporarily stored) and the MOG is deposited back onto the field. A second operation may be performed to gather the deposited MOG, or the MOG may be used as a fertiliser for the soil in the field. In either case, it is important for the MOG to be distributed evenly during deposition, in order to ensure an efficient second harvesting operation (e.g. bailing of the MOG) or to ensure effective fertilisation of the soil. When residue is unevenly distributed over a field, not only are exposed areas at risk for erosion, but inconsistencies in soil temperatures and moisture also may cause uneven plant emergence the following year, hurting yield. Ideally, residue should be spread consistently and managed to promote uniform rapid warming and drying in the spring for earlier planting and sufficient seed germination. It would therefore be beneficial to provide suitable systems and methods for monitoring operation of a spreader tool or equivalent components operating to spread the residue material to ensure they are operating effectively.

### BRIEF SUMMARY

In an aspect of the invention there is provided a system for monitoring the operation of one or more crop processing components of an agricultural harvesting machine, the system comprising: an event based sensor; and one or more controllers, configured to: receive sensor data from the event based sensor indicative of a measure of a flow of material from a spreader tool of the harvesting machine; analyse the sensor data to identify one or more anomalous flow regions with the material flow; and output one or more control signals for controlling operation of one or more operable components associated with the agricultural machine in dependence on the identified anomalous flow region(s).

Advantageously, the present disclosure utilises an event based sensor for monitoring operation of crop processing components of the harvesting machine, such as the cleaning system, chopper tool and/or spreader tool, for example, an in particular looking for plugging or blocking of said components with crop material. An event based sensor is particularly suited to monitoring movement, here a flow of material from the spreader tool into the surrounding environment of the harvesting machine. Accordingly, movement or flow of this material can be advantageously used to infer or monitor operational characteristics of the spreader tool by looking for anomalous regions within the material flow indicative of an operational issue with the one or more crop processing components of the machine.

When used herein and throughout the term “event based sensor” is intended to include a sensor having multiple individual sensing elements or pixels which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. Such a change may indicate movement in the observed environment, for example. Such sensor types may also be referred to as a neuromorphic camera, a silicon retina or dynamic vision sensor.

The one or more controllers may be configured to determine one or more flow parameter(s) for the material flow through performance of an optical flow measurement on the received sensor data. The optical flow measurement may provide a flow parameter comprising a measure of a direction, speed or velocity distribution associated with material movement within the sensing region of the sensor. The optical flow measurement may provide a measure of a uniformity of the material flow associated with the spreader tool. The one or more controllers may be operable to identify one or more anomalies in the optical flow measurement. The one or more anomalies may correspond to regions of the material flow exhibiting unusual flow parameters—e.g. a different speed or different flow direction when compared with other areas or regions of the material flow, or when compared with an expected flow parameter(s). The one or more controllers may be configured to determine the one or more anomalous flow regions in dependence on the identified anomaly(ies) in the optical flow measurement.

The flow parameter(s) may be compared with a baseline or expected parameter(s) for a given operating scenario. The baseline or expected parameter(s) may be preprogrammed based off calibration data, or may comprise an average or characteristic parameter(s) for the machine based off observations by the sensing arrangement of the system for ‘normal’ operation of the machine—i.e. where no anomalous regions are identified.

The flow parameter(s) may be analysed in dependence on one or more operating parameters of the machine or components associated therewith. For example, in some embodiments the one or more controllers are configured to receive operating data indicative of an operational speed of the machine or components thereof. The operational data may be used to define the baseline or expected flow parameter(s). For example, the one or more controllers may use the operational speed of the spreader tool to determine an expected flow parameter—e.g. flow speed, trigger frequency, etc.—for material flow associated with the spreader tool. Where the spreader tool operates periodically, a corresponding periodic triggering of respective sensing elements of the event based sensor may be expected. Where there is a change in the observed material flow compared with the operation of the spreader tool an anomalous region may be identified.

The baseline or expected parameter(s) for a given operating scenario may be determined in dependence on a measure or material flow into the machine. For instance, the system may comprise, or be configured to receive data from, a yield monitor or the like configured for obtaining a measure of an amount of material being harvested or processed by the machine at any given time. This may correlate to an amount of material spread or being spread by the spreader tool and as such an indication of an expected flow parameter(s) for the material flow associated with the spreader tool. This may advantageously prevent the system from erroneously identifying anomalous flow regions whilst the machine is passing through areas of low or no crop—e.g. during a headland turn for example.

The one or more controllers may be configured to analyse the sensor data to determine a material distribution associated with the spreader tool. This may include determining a shape or other measure of the distribution. The one or more controllers may be configured to determine an anomalous flow region in dependence on a change in the determined material distribution—e.g. a change in shape or size of the distribution.

The one or more controllers may be configured to compile the sensor data from the event based sensor in an event histogram. The histogram may correspond to a measure of a number of activations of individual sensing elements. The histogram may be generated over a time period during operation of the machine. The duration of the time period may be user definable or may be pre-programmed. The one or more controllers may be configured to determine one or more anomalous flow regions from the generated event histogram by identifying regions within the sensor data with a comparatively lower number of events compared with other regions of the sensor data—e.g. which may indicate a lower amount of material passing through the corresponding region of the sensing field.

The one or more controllers may be configured to perform a clustering process of events/triggers of individual sensing elements. The clustering may be a timewise and/or location based clustering to identify triggers at multiple sensing elements which correlate to the same physical observation. For instance, data may be clustered timewise to identify (and optionally track movement of) individual material components (e.g. pieces of straw or other crop material) in the sensor data. Clustering may be applied in dependence on a determined flow velocity of material (e.g. as determined through application of an optical flow measurement of the sensor data) which may be used to indicate regions within the field of view of the sensor where material may be travelling at different speeds to other regions or compared with an expected flow parameter. Regions within the sensing area where no or a lower number of triggers are seen (in areas where they would be expected—e.g. corresponding to a region of the spreader tool) may be indicative of a plugging of material or other fault preventing or reducing material flow in that region.

The one or more controllers may be configured to apply a filter to the sensor data. The filter may be applied to the sensor data to remove triggers of individual sensing elements due to background motion. For example, this may be due to the relative movement of the ground causing changes in the light incident on the sensing elements as the machine performs a task, or due to structural vibration and/or component motion during said tasks. Advantageously, applying one or more filters to the analogue output signal from the sensing elements may control the number of individual triggers to be processed by the event based sensor and/or one or more processing units associated therewith.

Additionally or alternatively, the one or more controllers may be configured to apply a filter to the sensor data. Where the processing capabilities of the controllers is high enough it may be possible to receive all triggers and apply said filter(s) digitally to remove or discard unwanted triggers.

The filter may comprise a threshold for a signal parameter associated with the sensing elements, which may include amplitude or rate of change of amplitude of the output signal. The threshold may be definable and/or be dependent on the agricultural task (to be) performed by the agricultural machine.

The filter may be dependent on a ground speed of the agricultural machine. Advantageously, the relative movement of the ground with respect to the machine, and hence the sensor, may be excluded from the sensor data. The filter may be dependent on an operational speed of one or more components of or associated with the machine, which may include a rotational speed or one or more rotational components of the spreader tool, for example.

The filter may comprise a mask applied to a sensing region of the sensor, e.g. to exclude regions of the sensing region which do not correspond to the spreader tool and/or a material flow associated therewith.

The system may include one or more additional sensors. Data from the one or more additional sensors may be useable by the one or more controllers for positioning of the spreader tool within the sensor data from the event based sensor, for example. The one or more additional sensors may comprise a camera, LIDAR unit, RADAR unit or the like.

The one or more operable components of or otherwise associated with the machine may include a user interface. The user interface may comprise a display screen, which may be provided as part of a user terminal of the machine, e.g. in an operator cab of the machine. Additionally or alternatively, the user interface may be provided by a portable user device, e.g. one carried by a user/operator during operation of the machine. The portable user device may comprise a smartphone, tablet computer, laptop or the like.

The one or more controllers may be configured to control output of an indicator indicative of the identified anomalous flow region(s). Specifically, the one or more controllers may be configured to generate and output a control signal(s) to the user interface for causing output of the indicator via the user interface to an operator of the machine.

The indicator may comprise a warning indicative of an identified anomaly in the material flow associated with the spreader tool, for example. The warning may be an audible and/or a visual warning.

The indicator may comprise a representation of the spreader tool and/or the material flow associated therewith. For example, the one or more controllers may be configured to control output of a graphical representation of the spreader tool and/or material flow via the user interface. This may comprise senor data (e.g. an image feed from the one or more additional sensors) and/or a generated virtual representation of the spreader tool, the material flow and/or an identified anomalous flow region.

The one or more controllers may be configured to controlling a forward speed of the machine, which may include modifying the speed and/or bringing the machine to a stop in dependence on an identification of an anomalous material flow.

Additionally or alternatively, the one or more controllers may be configured to control one or more components of the machine.

The component(s) of the machine may include a header for a harvesting machine, and the one or more controllers may be configured for controlling an operational speed of rotational elements of the header, which may include a reel, augers or the like. This may include controlling an operational speed of conveyors or other components. This may include controlling a lift mechanism for the header for controlling an operational position or height of the header. The one or more controllers may be configured for adjusting an operational state of the header—e.g. from a harvesting to a non-harvesting state—in dependence on the identification of one or more anomalous flow regions. This may prevent further material entering the machine where there is a possible plugging or blockage in a material flow through the machine.

The component(s) of the machine may include a crop processing apparatus of the machine, such as a cleaning and/or threshing system of the machine. The one or more controllers may be configured to adjust an operational speed of such components to control the speed at which crop material is processed and moved through the machine.

The component(s) of the machine may include the spreader tool. The one or more controllers may be configured to control an operational speed of the spreader tool to control the flow of material therethrough. This may include reducing the speed of the spreader tool and optionally bringing this to a stop in dependence on an identification of the anomalous flow region(s). This may advantageously prevent further overloading of the spreader tool and allow for clearing of any blockage or correcting of any fault associated therewith before further component fault.

The one or more controllers may collectively comprise an input (e.g. an electronic input) for receiving one or more input signals. The one or more input signals may comprise sensor data from the event based sensor. The one or more controllers may collectively comprise one or more processors (e.g. electronic processors) operable to execute computer readable instructions for controlling operation of the control system, for example, to identify the anomalous flow region(s). The one or more processors may be operable to generate one or more control signals for controlling operation of the one or more operational components. The one or more controllers may collectively comprise an output (e.g. an electronic output) for outputting the one or more control signals.

A further aspect of the invention provides an agricultural machine comprising the system of any aspect described herein. The agricultural machine may comprise a harvesting machine, such as a combine or forage harvester, for example.

A further aspect of the invention provides a method of monitoring the operation of one or more crop processing components of an agricultural harvesting machine, comprising: receiving sensor data from an event based sensor indicative of a measure of a flow of material from a spreader tool of the harvesting machine; analysing the sensor data to identify one or more anomalous flow regions with the material flow; and controlling operation of one or more operable components associated with the agricultural machine in dependence on the identified anomalous flow region(s).

The method may comprise performing any one or more of the functionalities of the control system described hereinabove.

A further aspect of the invention provides computer software comprising computer readable instructions which, when executed by one or more electronic processors, causes performance of a method in accordance with any aspect described herein.

A yet further aspect of the invention provides a computer readable medium having the computer software of the preceding aspect of the invention stored thereon.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a schematic side cross-sectional view of an agricultural harvester embodying aspects of the present disclosure;

FIG. 2 is a schematic view of an embodiment of a system of the present disclosure;

FIG. 3 illustrates sensor data obtained by a sensing arrangement forming part of aspects of the present disclosure; and

FIG. 4 is an image of residue material obtained utilising a camera illustrating the operational use of embodiments discussed herein.

### DETAILED DESCRIPTION

The present disclosure relates to systems and methods for monitoring the operation of one or more crop processing components of an agricultural harvesting machine, shown here as a harvester 10. This is done by analysing a flow of material from a spreader tool 22 of the harvester 10 utilising an event based sensor 30 mounted to the rear of the harvester 10 and observing material spread into the environment by the spreader tool 22. The event based sensor 30 obtains sensor data which is indicative of a measure of the material flow from the spreader tool 22 and this data is analysed, here by controller 102 of control system 101, to identify one or more anomalous flow regions within the material flow. Operation of one or more operable components associated with the harvester 10 (e.g. a user interface 32 or components of the spreader tool 22 or other crop processing apparatus and system of the harvester 10, for instance) can be controlled based on the identified anomalous flow region(s), in the manner discussed herein.

### Harvester

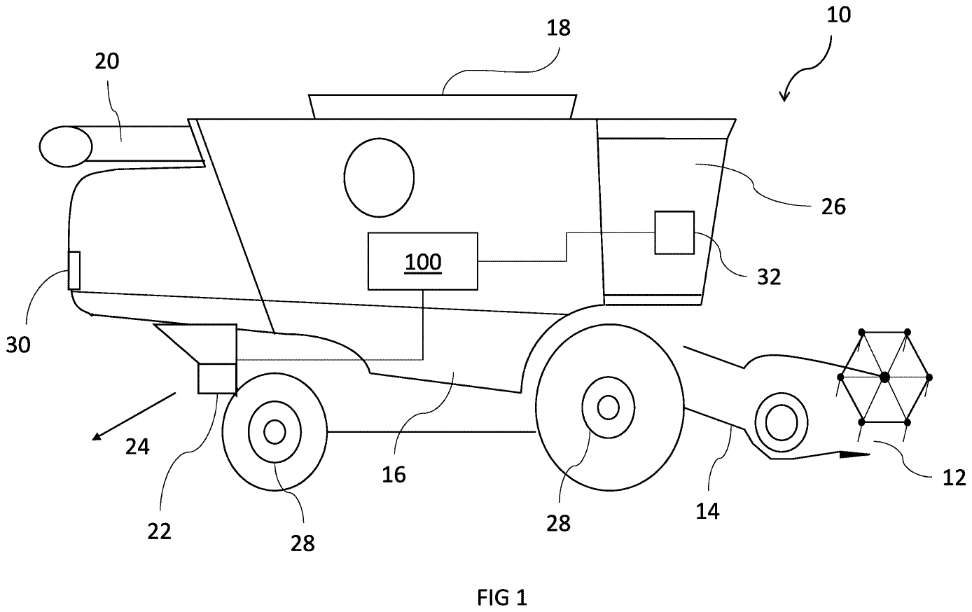

With reference to FIG. 1, an agricultural machine in the form of a harvester 10 is shown which embodies aspects of the present disclosure.

The harvester 10 is coupled to a header 12 which is operable, in use, to cut and gather a strip of crop material as the harvester 10 is driven across a field/area to be harvested during a harvesting operation. A conveyor section 14 conveys the cut crop material from the header 12 into a crop processing apparatus 16 operable to separate grain and non-grain (i.e. material other than grain (MOG) or residue material (used interchangeably herein)) as will be appreciated. It is noted here that apparatus for separating grain and non-grain material are well-known in the art and the present invention is not limited in this sense. The skilled person will appreciate that numerous different configurations for the crop processing apparatus may be used as appropriate. Clean grain separated from the cut crop material is collected in a grain bin 18, which may be periodically emptied, e.g. into a collection vehicle, storage container, etc. utilising unloading auger 20. The remaining non-grain material (MOG)/residue material is separately moved to a spreader tool 22 which is operable in use to eject the non-grain material or MOG from the rear of the harvester 10 and onto the ground. In FIG. 1, this is represented by arrow 24 which illustrates the MOG being ejected rearwards from the harvester 10. It will be appreciated that in some embodiments the harvester 10 may also include a chopper tool positioned, for example, between the crop processing apparatus 16 and the spreader tool 22 and operable, in use, to cut the residue material before it is spread by the spreader tool 22.

The harvester 10 also typically includes, amongst other features, an operator cab 26, wheels 28, engine (not shown) and a user interface in the form of a display terminal 32 provided within the operator cab 26.

### Event Based Sensor

As will be discussed in detail herein, the harvester 10 additionally includes a sensor in the form of an event based sensor 30. The sensor 30 is mounted to a rear of the harvester 10 in the illustrated embodiment, and has a field of view which encompasses an operating region of the spreader tool 22, specifically here the region of the working environment directly behind the harvester 10 into which material is spread by the spreader tool 22. Event based sensor 30 is used, by a control system 101 of the harvester, to identify one or more anomalies in the material flow associated with the spreader tool 22 in the manner discussed herein.

Event based sensor 30 has multiple individual sensing elements (pixels) which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. The variations can be used as an indication of movement in the observed environment, for example, by monitoring successive triggers of adjacent sensing elements, and inferring movement in the observed scene based thereon. In further arrangements the overall sensor output for a given time period may be used—e.g. forming of a histogram or heat map of triggers—to obtain a measure of an overview of a given process—e.g. shape/size of flowpath or material distribution, etc.

Operation of the event based sensor 30 may be controlled based on the given scenario. For instance a filter may be applied to the sensing elements to control at what magnitude of change/variation said sensing elements are triggered. This may be utilised to remove background events from the data. For instance, in the presently illustrated embodiment using the sensor 30 on the harvester 10 during a harvesting operation, motion of the ground with respect to the harvester 10 may otherwise trigger the sensing elements. Accordingly, a filter can be applied based on the ground speed of the harvester 10 to reduce or eliminate false triggers thereof. In alternative arrangements, the operational speed of the components of the harvester 10, e.g. a rotational speed of elements of the spreader tool 22, may be used to determine the filter to be applied to the sensor data to remove cyclical or repetitive motion from the scene—e.g. in order to identify anomalies or changes in that motion indicative of an operational issue.

In yet further use cases, a clustering process may be applied to the sensor data. This clustering may be a timewise and/or location based clustering to identify triggers at multiple sensing elements which correlate to the same physical observation. For instance, data may be clustered timewise to identify (and optionally track movement of) individual material components (e.g. pieces of straw or other crop material) in the sensor data. Clustering may be applied in dependence on a determined flow velocity of material (e.g. as determined through application of an optical flow measurement of the sensor data) which may be used to indicate regions within the field of view of the sensor where material may be travelling at different speeds to other regions or compared with an expected flow parameter. Regions within the sensing area where no triggers are seen (in areas where they would be expected) may be indicative of a plugging of material or other fault preventing material flow in that region.

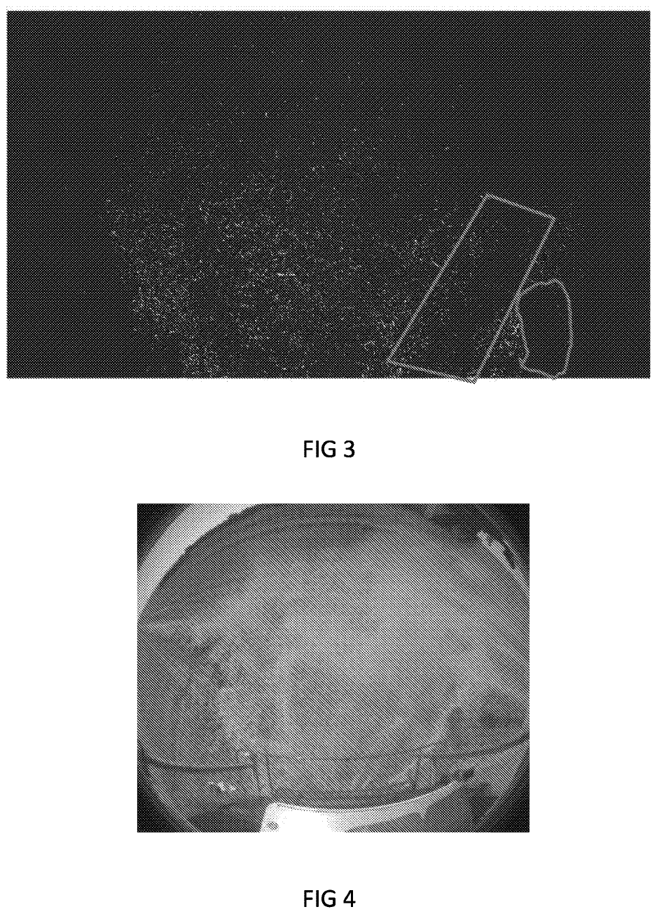

FIG. 3 illustrates a representation of sensor data obtained during operation of the harvester 10. Here, “triggered” sensing elements of the event based sensor 30 are shown indicative of movement in the region of the environment corresponding to the relevant pixel in the displayed sensor data. FIG. 4 illustrates the same scene utilising a camera based system with residue material shown being spread behind the rear of a harvester. As shown, through suitable processing of the sensor data via filters and the like, only those triggers in response to movement of residue material within the observed region is present in the generated representation. This removes background noise/triggers from the data enabling a better representation of the residue distribution.

In the present disclosure and the embodiment displayed herein, two anomalous regions are identified in FIG. 3 where a smaller or no triggers are seen for the particular snapshot when compared with other regions across the material flow from the spreader tool 22. This is analysed and identified in the manner discussed hereinbelow for identifying potential issues with the spreader tool 22, or other crop processing systems of the harvester 10.

### System

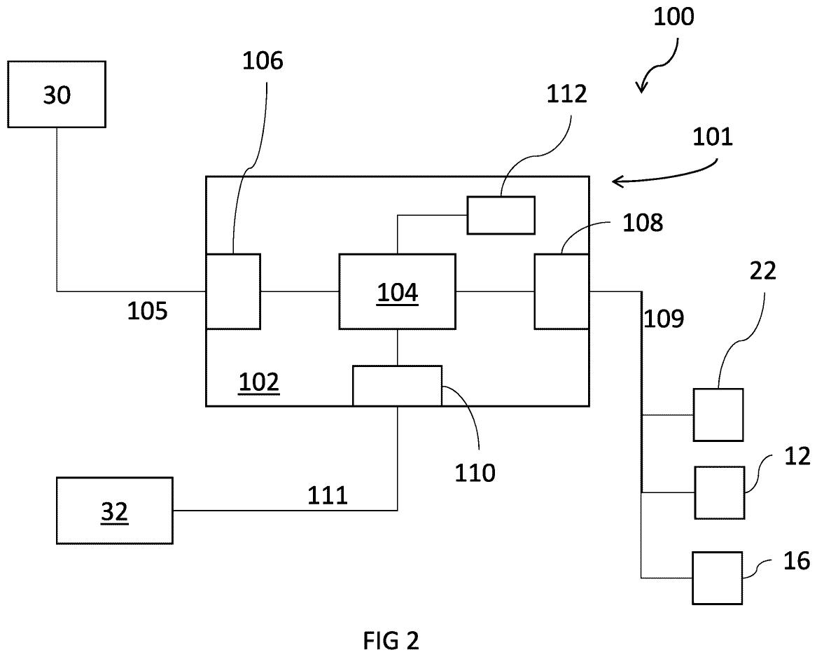

FIG. 2 illustrates system 101 further. As shown, the system incorporates a control system 100 here having a single controller 102. The controller 102 includes an electronic processor 104, an electronic input 106 and electronic outputs 108, 110. The processor 104 is operable to access a memory 112 of the controller 102 and execute instructions stored therein to perform the steps and functionality of the present invention, for example to output control signals 109 via the output 108 for controlling operation of the spreader tool 22, or for controlling operation of the header 12 or components thereof, or for controlling operation of the crop processing apparatus 16 or for controlling the display terminal 32, for example to provide an image to an operator of the harvester 10 illustrative of the observed residue material distribution and one or more anomalous flow regions identified therein.

The processor 104 is operable to receive sensor data via input 106 which, in the illustrated embodiment, takes the form of input signals 105 received from the event based sensor 30. As described in detail herein, the event based sensor 30 has a sensing region rearward of the harvester 10, with the sensor data received from the sensor 30 being indicative of a measure of a flow of material within the sensing region associated with the operation of the spreader tool 22. Using this information, the processor 104 is operable to identify one or more anomalous flow regions within the material flow.

Specifically, the processor 104 is analyse the sensor data received from the event based sensor 30 to through performance of an optical flow analysis on the received sensor data for extracting flow parameters for the material flow indicative of the direction and/or velocity of material flow associated with the spreader tool 22. From this, one or more anomalous regions are identified as regions which exhibit different flow parameters to other regions of the header. Turning back to FIG. 3, two areas are shown highlighted which exhibit different flow parameters in the sensor data. Specifically in these regions a relatively low number of event triggers are seen in the sensor data. In turn, this results in a now or low flow velocity in this region from the optical flow analysis when compared with the flow in other regions of the sensor data where a relatively large number of triggers are seen. In this example, this may be illustrative with a potential spreader tool issue where the material is not being spread in a given direction.

In variants, the controller 102 is configured to compare the flow parameter(s) one or more expected parameter(s) for a given operating scenario. The baseline or expected parameter(s) may be preprogrammed based off calibration data, or may comprise an average or characteristic parameter(s) for the machine based off observations by the sensing arrangement of the system 100 for ‘normal’ operation of the machine—i.e. where no anomalous regions are identified. The flow parameter(s) can be analysed in dependence on one or more operating parameters of the harvester 10 or components associated therewith. For example, operating data indicative of an operational speed of the harvester 10 or components thereof, including the spreader tool 22 can be used to determine an expected flow parameter which may include an expected flow speed, an expected trigger frequency for the sensing elements, etc. for material flow associated with the spreader tool. This can account for scenarios wherein the spreader tool 22 operates periodically, and a corresponding periodic triggering of respective sensing elements of the event based sensor may be expected. Where there is a change in the observed material flow compared with the operation of the spreader tool 22 an anomalous region may be identified by the controller 102 and appropriate action be taken in dependence thereon.

In further variants, the baseline or expected parameter(s) for a given operating scenario can be determined in dependence on a measure or material flow into the harvester 10. For instance, the system 100 can additionally comprise, or be configured to receive data from, a yield monitor or the like configured for obtaining a measure of an amount of material being harvested or processed by the harvester 10 at any given time. This can be used as an indicator of an expected amount of material spread or being spread by the spreader tool 22.

In yet further variants, the controller 102 is configured to analyse the sensor data from the event based sensor 30 to determine a material distribution associated with the spreader tool 22, which can include determining a shape or other measure of the distribution. An anomalous flow region can then be determined based on identification of a sudden or abrupt change in the determined material distribution, which may include a change in shape or size of the distribution.

Turning back to FIG. 2, the output 110 is operably coupled to the display terminal 32 of the harvester 10. Here, the control system 101 is operable to control operation of the display terminal 32, e.g. through output of control signals 111 in order to display operational data to an operator of the harvester 10 relating to the operation of the control system 101. Specifically, the control system 101 may be operable to control the display terminal 32 to display to the operator a graphical representation of the material distribution from the spreader tool 22 as determined by processor 104, sensor data from the event based sensor 30, image data obtained from a camera on the harvester 10, or other useful information, including a graphical indicator highlighting one or more anomalous flow regions in the material flow, for example. In some variants, the display terminal 32 may also be operable to receive a user input from the operator, and in such instances the output 110 may act as an input for receiving that user input at the processor 104. The operator can use this presented information to inform next steps, including further manual investigation of potential issues highlighted by the anomalous material flow, for example.

The system 100 shown in FIG. 2 also includes the spreader tool 22 being operably connected to the controller 102 via output 108. It will be appreciated that the spreader tool 22 may include a local control unit serving as a communication module between the controller 102 and the spreader tool 22 and for controlling operation thereof under instruction from the controller 102. Here, the control system 101 is configured to control operation of the spreader tool 22 in dependence on the identification of one or more anomalous flow regions. For instance, the control system 101 can be configured to control an operational speed of components of the spreader tool 22 in dependence on the identification of an anomaly, e.g. to reduce the operational speed to prevent damage to the tool 22 in the event of a blockage, or to increase the speed of the tool 22 in an attempt to dislodge or remove blocked material from the spreader tool 22.

The system 100 shown in FIG. 2 also includes the header 12 of harvester 10 being operably connected to the controller 102 via output 108. Again, it will be appreciated that the header 12 may include a local control unit serving as a communication module between the controller 102 and the header 12 and for controlling operation thereof under instruction from the controller 102. Here, the control system 101 is configured to control operation of the header 16 in dependence on the identification of one or more anomalous flow regions. For instance, the control system 101 can be configured to control an operational speed of components of the header 12 in dependence on the identification of an anomaly, e.g. to reduce the flow of material into the harvester 10 in the event of a blockage or plugging of components of the harvester 10 as determined by the flow associated with the spreader tool 22. This may include controlling an operational speed of rotational elements of the header 12, which may include a reel, augers or the like as will be appreciated. This may include controlling an operational speed of conveyors or other components. This may include controlling a lift mechanism for the header 12 for controlling an operational position or height of the header 12. This may include adjusting an operational state of the header 12—e.g. from a harvesting to a non-harvesting state—in dependence on the identification of one or more anomalous flow regions.

The system 100 shown in FIG. 2 also includes the crop processing apparatus 16 being operably connected to the controller 102 via output 108. Again, it will be appreciated that the crop processing apparatus 16 may include a local control unit serving as a communication module between the controller 102 and the apparatus 16 and for controlling operation thereof under instruction from the controller 102. Here, the control system 101 is configured to control operation of the crop processing apparatus 16 in dependence on the identification of one or more anomalous flow regions. For instance, the control system 101 can be configured to control an operational speed of components of the apparatus—e.g. sieves, concaves, augers, shakers, elevators etc. in dependence on the identification of an anomaly, e.g. to reduce the flow of material through the machine to prevent or reduce the likelihood of further damage/blockage of material in the harvester 10.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A system for monitoring the operation of one or more crop processing components of an agricultural harvesting machine, the system comprising:
an event based sensor; and
one or more controllers, configured to:
receive sensor data from the event based sensor indicative of a measure of a flow of material from a spreader tool of the harvesting machine;
analyse the sensor data to identify one or more anomalous flow regions with the material flow; and
output one or more control signals for controlling operation of one or more operable components associated with the agricultural machine in dependence on the identified anomalous flow region(s).

2. A system as claimed in claim 1, wherein the one or more controllers are configured to determine one or more flow parameter(s) for the material flow through performance of an optical flow measurement on the received sensor data.

3. A system as claimed in claim 2, wherein the one or more controllers are operable to:
identify one or more anomalies in the optical flow measurement; and
determine the one or more anomalous flow regions in dependence on the identified anomaly(ies) in the optical flow measurement.

4. A system of claim 2, wherein the one or more controllers are configured to analyse the flow parameter(s) in dependence on one or more operating parameters of the machine or components associated therewith.

5. A system of claim 4, wherein the one or more controllers are configured to: receive operating data indicative of an operational speed of the spreader tool;
determine an expected flow parameter for material flow associated with the spreader tool in dependence on the operational speed of the spreader tool; and
identify an anomalous flow region in dependence on a comparison of the determined flow parameter with the expected flow parameter.

6. A system of claim 1, comprising, or being configured to receive data from, a yield monitor or the like configured for obtaining a measure of an amount of material being harvested or processed by the machine at any given time.

7. A system of claim 1, wherein the one or more controllers are configured to:
analyse the sensor data to determine a material distribution associated with the spreader tool; and
determine an anomalous flow region in dependence on a change in the determined material distribution.

8. A system of claim 1, wherein the one or more controllers are configured to:
compile the sensor data from the event based sensor in an event histogram; and
determine one or more anomalous flow regions from the generated event histogram by identifying regions within the sensor data with a comparatively lower number of events compared with other regions of the sensor data.

9. A system of claim 1 configured to control application of a filter to the output signals from individual sensing elements of the event based sensor to remove triggers thereof due to background motion.

10. A system of claim 9, wherein the filter is dependent on a ground speed of the agricultural machine and/or an operational speed of one or more components of or associated with the machine.

11. A system of claim 1, wherein the one or more operable components of or otherwise associated with the machine includes a user interface.

12. A system of claim 11, wherein the one or more controllers are configured to control output of an indicator indicative of the identified anomalous flow region(s).

13. A system of claim 12, wherein the indicator comprises:
an audible or visual warning indicative of an identified anomaly in the material flow associated with the spreader tool, for example. The warning may be an audible and/or a visual warning; and/or
a representation of the spreader tool, the material flow associated therewith; and/or an graphical indicator of an identified anomalous flow region.

14. A system of claim 1, wherein the one or more controllers are configured to control a forward speed of the machine in dependence on an identification of an anomalous material flow.

15. A system of claim 1, wherein the one or more controllers are configured to control one or more components of the machine in dependence on an identification of an anomalous material flow.

16. A system of claim 15, wherein the component(s) of the machine comprises a header for the machine, and wherein the one or more controllers are configured for controlling an operational speed of elements of the header, a lift mechanism for the header for controlling an operational position or height of the header, and/or an operational state of the header.

17. A system of claim 15, wherein the component(s) of the machine comprises a crop processing apparatus of the machine, and wherein the one or more controllers are configured to adjust an operational speed of components of the crop processing apparatus to control the speed at which crop material is processed and moved through the machine.

18. A system of claim 15, wherein the component(s) of the machine comprises the spreader tool, and wherein the one or more controllers are configured to control an operational speed of the spreader tool to control the flow of material therethrough.

19. An agricultural machine comprising the system of claim 1.

20. A method of monitoring the operation of one or more crop processing components of an agricultural harvesting machine, comprising:
receiving sensor data from an event based sensor indicative of a measure of a flow of material from a spreader tool of the harvesting machine;
analysing the sensor data to identify one or more anomalous flow regions with the material flow; and
controlling operation of one or more operable components associated with the agricultural machine in dependence on the identified anomalous flow region(s).
